(19) United States
(12) Patent Application Publication
(10) Pub. No.: US 2018/0057268 A1
(43) Pub. Date: Mar. 1, 2018

(54) Transportable Modular System For Packaging Items

(71) Applicant: OTG Experience, LLC, New York, NY (US)

(72) Inventors: Eric J. Blatstein, New York, NY (US); Ronald M. Falocco, New York, NY (US); Thomas A. Hillerich, JR., Louisville, KY (US); Gabriel A. Difurio, Stevenson, MD (US)

(21) Appl. No.: 15/245,811

(22) Filed: Aug. 24, 2016

(51) Int. Cl. B65G 37/00; B65G 47/38; G06Q 30/06; B60P 3/14

(52) U.S. Cl. CPC B65G 37/00; B60P 3/14; G06Q 30/0633; B65G 47/38

(57) ABSTRACT

A transportable system for packaging items in a container is mounted to and enclosed by a truck. The system includes an item tote having a base and at least one sidewall extending from the base. The system also includes a conveyor configured to transport the item tote within the truck. The conveyor has an actuatable portion that is configured to tilt the item tote. The system also has dispensing carts located above the conveyor and removable from the truck for loading items into the dispensing carts while the dispensing carts are outside of the truck. The system also has a container chute. In operation, items are dispensed from the dispensing carts into the item tote and transported by the conveyor to a container disposed in the container chute.

### CROSS-REFERENCE TO RELATED APPLICATION

This application is related by subject matter to U.S. Pat. No. 9,114,748, which granted on Aug. 25, 2015, the disclosure of which is incorporated by reference herein.

### TECHNICAL FIELD

This disclosure relates generally to a transportable system for packaging items.

### BACKGROUND

Conventional food delivery systems for passengers of various types of transportation, including airplanes and trains, prepackage predetermined orders into discrete packages that, after they are placed on the plane or train, are selected by passengers. For example, after boarding an airplane or train, a passenger will be given a choice between a vegetarian meal and a standard meal. While these systems minimized time requirements for reloading an airplane or train prior to a flight, they have several drawbacks, including the inability to handle customized food orders, possible inaccuracy of matching a passenger's choices to the available food or beverage, and the like. Beyond providing a choice to passengers of two or three preset orders, individually customized food orders, such as those selected by the passenger prior to boarding an airplane or train, were not considered possible by the food delivery industry.

### SUMMARY

According to an aspect of the present invention, a system is provided that enables a customer to select from several food and beverage choices, and the system diminishes the time required to rapidly provide a package having the selected food and beverage to a predetermined location, such as a commercial airplane or train, in a time-sensitive environment.

In a first aspect of the present disclosure, A transportable system for packaging items in a container is mounted to and enclosed by a truck. The system includes an item tote having a base and at least one sidewall extending from the base. The system also includes a conveyor configured to transport the item tote within the truck. The conveyor has an actuatable portion that is configured to tilt the item tote. The system also has dispensing carts located above the conveyor and removable from the truck for loading items into the dispensing carts while the dispensing carts are outside of the truck. The system also has a container chute. In operation, items are dispensed from the dispensing carts into the item tote and transported by the conveyor to a container disposed in the container chute.

In a second aspect of the present disclosure, a method of packaging items in a container uses a transportable system. The system is mounted to and enclosed by a truck. The system includes an item tote that has a base and at least one sidewall extending from the base. The system also includes a conveyor and dispensing carts located above the conveyor and removable from the truck for loading items into the dispensing carts while the dispensing carts are outside of the truck, as well as a container chute. The method includes a step of disposing items in the item tote. The method also includes a step after the disposing step, of transporting the item tote from an area within the truck where the dispensing carts are disposed to the container chute. Additionally, after the transporting step, the method includes a step of moving the items from the item tote into the container.

In a third aspect of the present disclosure, a transportable system for packaging items in a container is mounted to and enclosed by a truck. The container has a base and at least one sidewall extending from the base. The system includes a container former that has a pair of dowels which each include a rotatable tab extending radially relative to the dowel. The container former also has a vacuum arm that is configured to apply a vacuum force to the container during forming and a linear actuator mounted to the vacuum arm. The linear actuator is configured to move the vacuum arm relative to a portion of the container during forming. The system also includes an item tote that has a base and at least one sidewall extending from the base. The base includes a door that is actuatable relative to the at least one sidewall. The system also includes a conveyor configured to transport the item tote within the truck. The conveyor defines a recess that, in combination with the door, is configured to form a pathway from the item tote to the container former such that the items may be disposed in the container after the container is formed.

### BRIEF DESCRIPTION OF THE DRAWINGS

The foregoing summary, as well as the following detailed description of illustrative embodiments of the transportable system for packaging items of the present application, will be better understood when read in conjunction with the appended drawings. For the purposes of illustrating the transportable system for packaging items of the present application, there is shown in the drawings illustrative embodiments. It should be understood, however, that the application is not limited to the precise arrangements and instrumentalities shown. In the drawings:

FIG. 1 is a schematic of representation of a transportable system for packaging items that is mounted to and enclosed by a truck;

FIG. 2 is a schematic representation of the transportable system mounted to the truck shown in FIG. 1;

FIG. 3 is a schematic representation of the transportable system shown in FIG. 2 with portions cut away;

FIG. 4 is a schematic representation of a portion of the transportable system shown in FIGS. 2 and 3, according to one aspect of the present disclosure, the portion shown in FIG. 4 depicting an item tote and a conveyor;

FIG. 5 is a schematic representation of the item tote and the conveyor shown in FIG. 4;

FIG. 6 is a schematic representation of the item tote shown in FIGS. 4 and 5;

FIG. 7 is a schematic representation of a portion of the transportable system shown in FIGS. 5 and 6, depicting the item tote, the conveyor, a container former;

FIG. 8A is a schematic representation of a portion of the transportable system shown in FIGS. 5-7, depicting the container former and a container chute;

FIG. 8B is a schematic representation of a portion of the transportable system shown in FIGS. 5-8A, depicting the container former, the container chute, and container totes;

FIG. 9 is a schematic representation of a portion of the transportable system shown in FIGS. 5-7, depicting the container former, the container chute, and container totes;

FIG. 10 is a schematic representation of a portion of the transportable system shown in FIGS. 2 and 3, according to another aspect of the present disclosure, the portion shown in FIG. 10 depicting a container former, an item tote, and a conveyor;

FIG. 11 is a schematic representation of a portion of the transportable system shown in FIG. 10, depicting the item tote and the conveyor;

FIGS. 12A and 12B are schematic representations of the item tote shown in FIGS. 10 and 11;

FIG. 13 is a schematic representation of a container according to another aspect of the present disclosure; and

FIGS. 14A-14F are schematic representations of the container former shown in FIG. 10 and the container shown in FIG. 13.

### DETAILED DESCRIPTION OF THE ILLUSTRATIVE EMBODIMENTS

Aspects of the disclosure will now be described in detail with reference to the drawings, wherein like reference numbers refer to like elements throughout, unless specified otherwise. Certain terminology is used in the following description for convenience only and is not limiting.

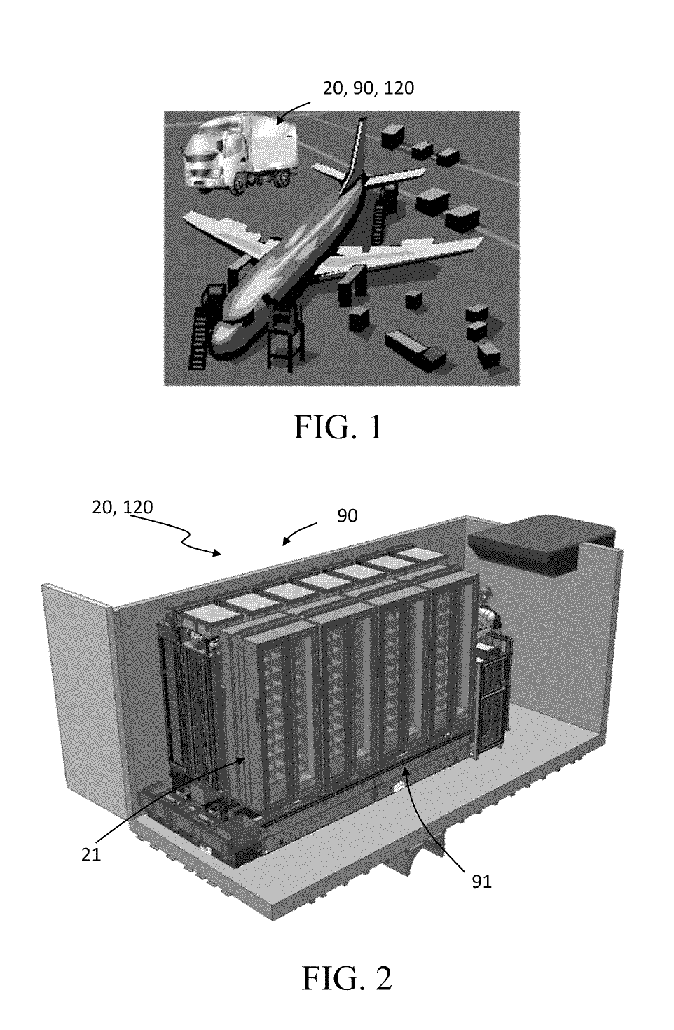

Referring to FIG. 1, a transportable system 20, 120 packages items 99 in containers 100, 100′. The transportable system is mounted to and enclosed in a truck 90. For example, items 99 may be intended for multiple airplane passengers and may include pre-packaged food, beverage, and small non-food items (e.g. headphones, earplugs, and/or eye masks). Each passenger may order a set of items 99 that are then packaged together in a container 100, 100′ using the transportable system 20, 120. The container 100 may then be delivered to the passenger's seat prior to travel.

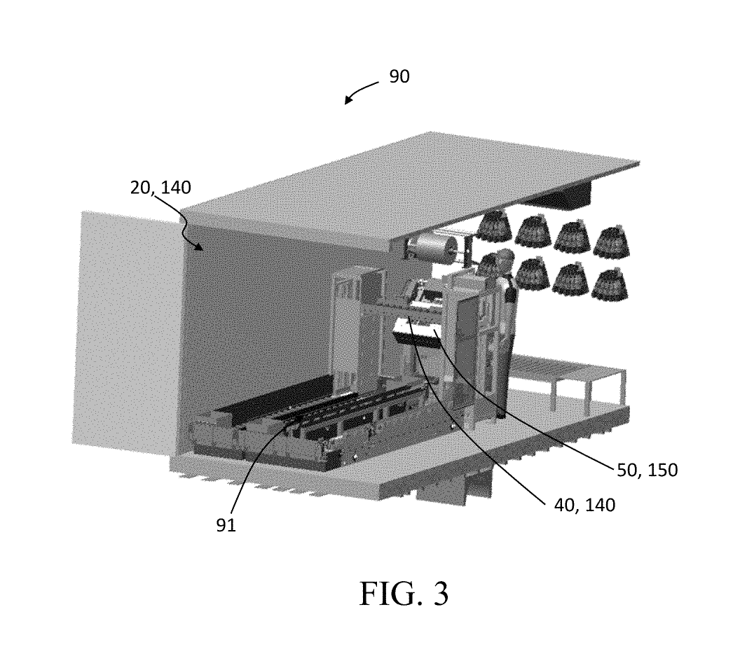

FIGS. 2 and 3 depict interior views of the truck 90 shown in FIG. 1. Items 99 are disposed in dispensing carts 21 over a conveyor 40, 140. Dispensing carts 21 release items 99 into item totes 30, 130 that are carried by the conveyor 40, 140 from an area 91 in which the dispensing carts 21 are disposed to a packaging system 50, 150.

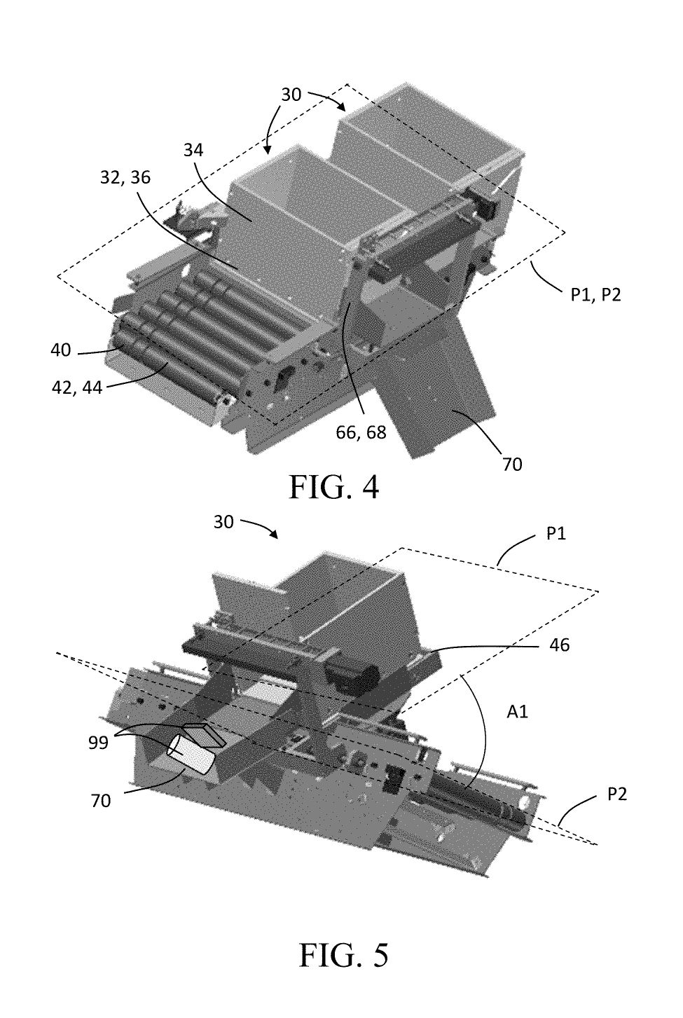

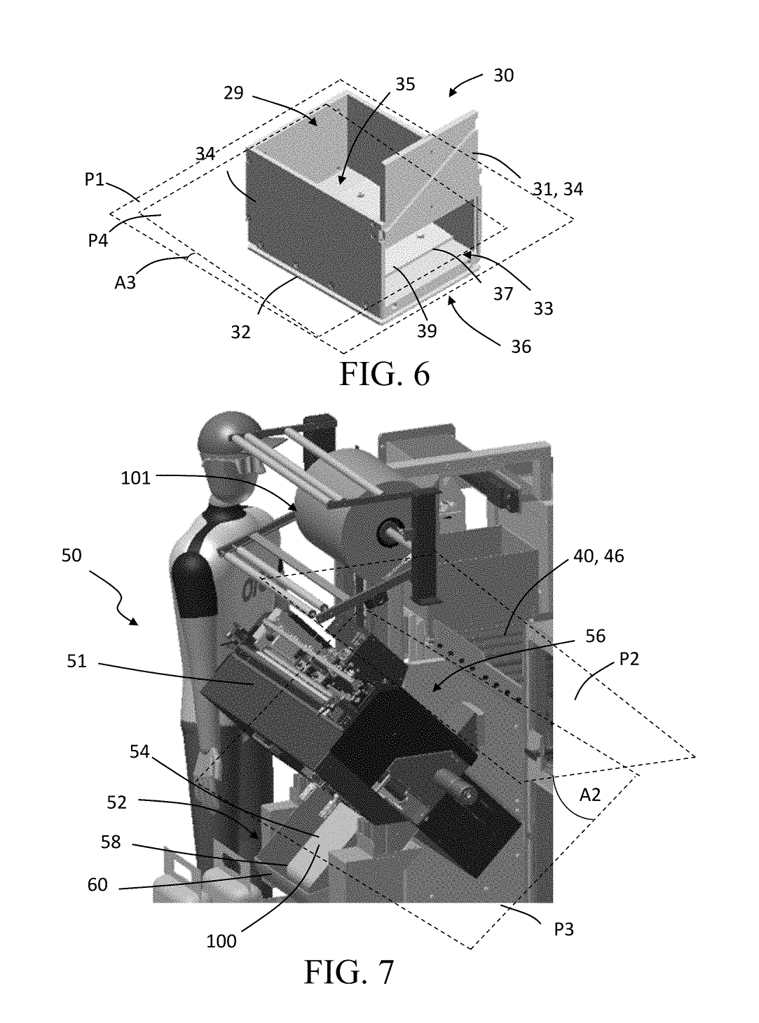

Referring now to FIGS. 4-9, item totes 30 each have a base 32 and at least one sidewall 34 that extends from the base 32. For example, with reference to FIG. 6, item tote 30 has a generally rectangular cuboid shape and defines an aperture 29 through which items 99 pass from the dispensing carts 21 into the tote 30. The at least one sidewall 34 includes four sidewalls 34. One of the sidewalls 34 includes a door 31 that is configured to actuate from a first position (shown in FIG. 4) to a second position (shown in FIGS. 5 and 6) to form an aperture 33. An entire sidewall 34 may comprise the door 31 which may, for example, be secured to the other sidewalls 34 using a pair of grooves, such as S-shaped grooves that correspond to S-shaped protrusions on the door 31. Door 31 is configured to be slideable relative to the other sidewalls 34. In other embodiments, tote 30 may have, for example, a cylindrical shape and a single sidewall 34 that includes the door 31.

With reference to FIG. 6, the base 32 of item tote 30 has a bottom surface 36 that defines a plane P1. Base 32 also has an inner surface 35 that is opposite the bottom surface 36 that defines another plane P4. Plane P1 and plane P4 are disposed relative to each other at an angle A3 between 0 and 15 degrees. For example, A3 may be between 0 and 10 degrees, or between 5 and 10 degrees. Item tote 30 may also include a lip 37 disposed between the inner surface 35 and the at least one sidewall 34.

During use, items 99 dropped into tote 30 may move (e.g, roll) along the inner surface 35 towards a low point 39 on the inner surface, and over lip 37 due to the angle A3 and gravity. Lip 37 inhibits items 99 from moving back onto inner surface 35. For example, dispensing carts 21 may be configured along conveyor 40 such that heavier and more structurally stable items (e.g., a can of soda) are placed (e.g., dropped) into the item tote 30 prior to lighter and less structurally stable items (e.g., a bag of chips). When a heavier item 99 is placed into the item tote 30, gravity will move the heavier item 99 down the inner surface 35 to the low point 39 and over lip 37 where it is held near door 31. Lighter and less structurally sound items 99 may then be placed into item tote 30, for example, in order of heaviest to lightest items, or in order of most structurally sound to least structurally sound, or a combination thereof.

After a tote 30 arrives at packaging system 50 on conveyor 40, a cam 66 mounted to a linear actuator 68 actuates door 31 to form the aperture 33. For example, the cam 66 may engage the at least one of the grooves in item tote 30 and the linear actuator 68 may move the cam 66 upward relative to the bottom 36 of the item tote 30 to form aperture 33. Items 99 are then moved from the item tote 30 into a container 100, with items closest to the door 31 (for example, a soda) dropping into the container 100 first after passing through the aperture 33 and down an item chute 70. As shown in FIGS. 7-9, items 99 are moved from the item tote 30 through the item chute 70 and into the container 100 using gravity. Item chute 70 may have a narrowing width such that the top of the item chute 70 has a width that is greater than a width of the bottom of the item chute 70. For example, the top of the item chute 70 may have a width that is equal or approximately equal to (e.g., within 1 inch) the width of the aperture 33 of the item tote 10 and the bottom of the item chute 70 may have a width that is less than a width of the container 100.

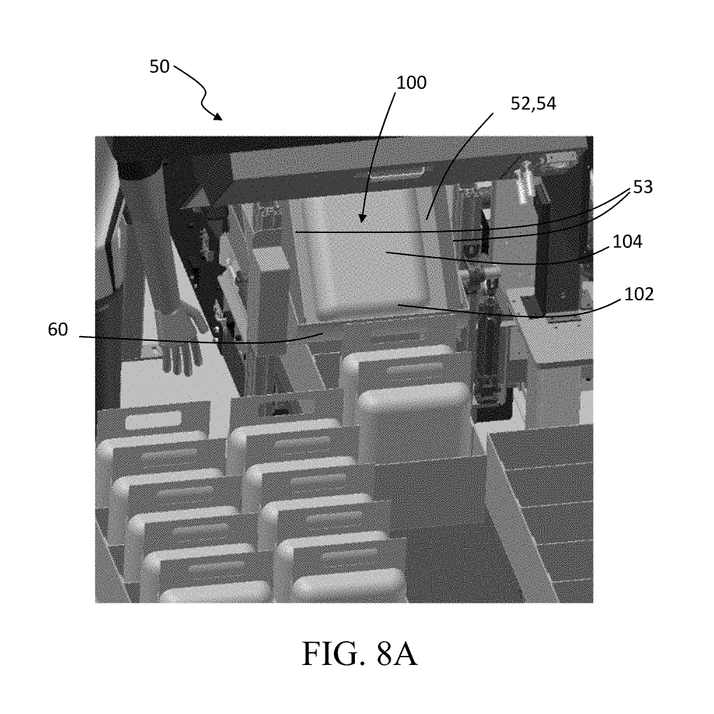

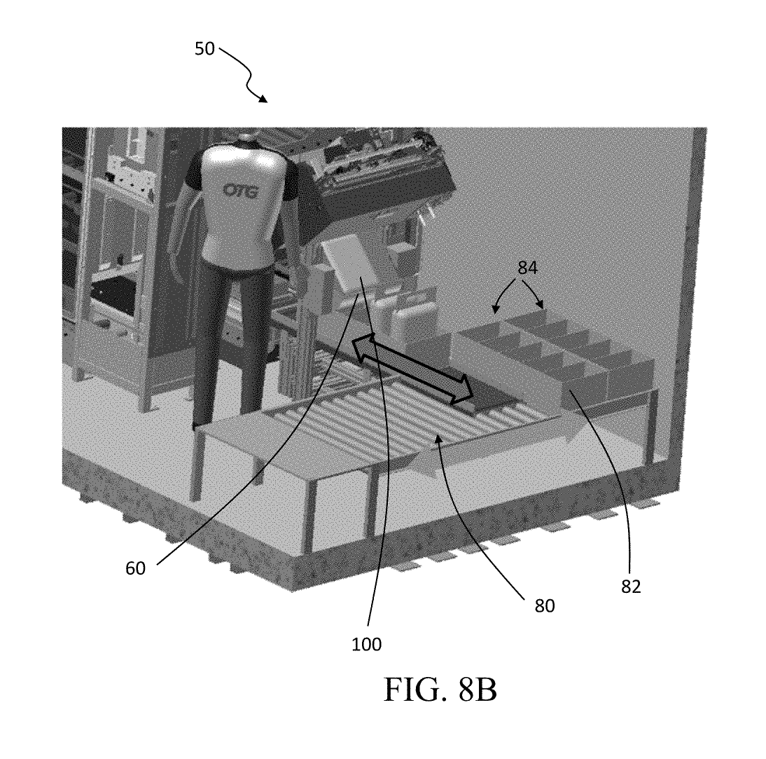

With reference to FIG. 8A, each container 100 includes a base 102 having at least one sidewall 104 extending from the base. For example, container 100 may have an ovular cylindrical shape. Alternatively, container 100 may have a cuboid shape.

The conveyor 40 that transports the item totes from the dispensing carts 21 to the packaging system 50 has a top surface 42 that is configured to contact the bottom surface 36 of the item tote 30. As shown in relation to FIGS. 4 and 5, the top surface 42 has a main portion 44 that defines a plane P2. The top surface 42 of the conveyor 40 also has an actuatable portion 46 that is configured to tilt the item tote 30 from a first position (shown in FIG. 4) to a second position (shown in FIG. 5). In the first position, before actuatable portion 46 tilts the item tote 30, plane P2 is coplanar with plane P2 (defined by the bottom surface 36 of the item tote 30). In the second position, after actuatable portion 46 tilts the item tote 30, plane P1 is angled relative to plane P2 at an angle A1 that is between 0 and 60 degrees. For example, A1 may be between 15 and 45 degrees, such as between 30 and 45 degrees or such as between 20 and 40 degrees, such as between 25 and 35 degrees.

Angle A1 may be optimized so that, in combination with angle A3, items 99 move out of the item tote 30 at a velocity and acceleration that minimizes damage to the items (for example, a bag of chips), and the container 100 (for example, a paper bag). Velocity and acceleration of items 99 may also be optimized through changing the coefficients of friction on an interior surface (including inner surface 35) of the item tote 30 and the item chute 70. For example, surfaces with relatively higher coefficients of friction may be used to slow the velocity and acceleration of items as they pass into container 100.

In order for packaging system 50 to capture items 99, in the container 100 as they move out of item tote 30, packaging system 50 forms the container 100. For example, in relation to FIG. 7, container 100 may be a plastic bag that has an initial configuration in which it is part of a roll 101 of bags. An expander 51 removes a container 100 from the roll 101, breaking the webbing between the container 100 and the next container 100 on the roll 101 and expands the container 100 from a compressed state using, for example, a puff of air.

With reference to FIG. 7, once the container 100 is in its expanded state, it is supported on a container chute 52 and a shelf 60 under the actuatable portion 46 of the conveyor 40. The container chute 52 has a surface 54 that extends between a top portion 56 of the container chute 52 that is proximate the actuatable portion 46 and a bottom portion 58. The surface 54 of the container chute 52 defines a plane P3 that is disposed an angle A2 relative to the plane P2 (defined by the top surface 42 of the main portion 44 of the conveyor 40). The angle A2 may be equal or approximately equal to the angle A1 (defined by the tilted second position of the item tote 30). For example, A2 may be within 10 degrees of A2, such as between 0 and 8 degrees, such as between 0 and 5 degrees. In one specific example, A1 may be 40 degrees and A2 may be 45 degrees. Like angle A1, angle A2 may be optimized so that items 99 roll into container 100 at a velocity and acceleration that minimizes damage to the items (for example, a bag of chips), and the container 100 (for example, a paper bag).

The container chute 52 may include walls 53 that extend outward from the surface 54 from the top portion 56 to the bottom portion 58 to hold container 100 in place during filling. For example, walls 53 may extend approximately perpendicular to surface 54. In its first position, shelf 60 also extends outward from the surface 54 to support the base 102 of the container 100. Shelf 60 supports the base 102 of the container 100 so that as items 99 drop into the container 100, other portions of the container 100, such as the handle, are not put under stress that could cause tearing of the container. As shown in FIG. 8A, shelf 60 may have a partially cylindrical shape that is rotatable relative to container chute 52 such that shelf 60 rotates from its first position in which it supports the base 102 of the container to a second position in which the shelf 60 is underneath container chute 52 so as to release the container 100. Due to its partial cylindrical shape, and because it is rotatable, in its second position underneath container chute 52, shelf 60 is compressed against the container chute 52 so as to maximize distance between a bottom of the shelf 60 and a second conveyor 80.

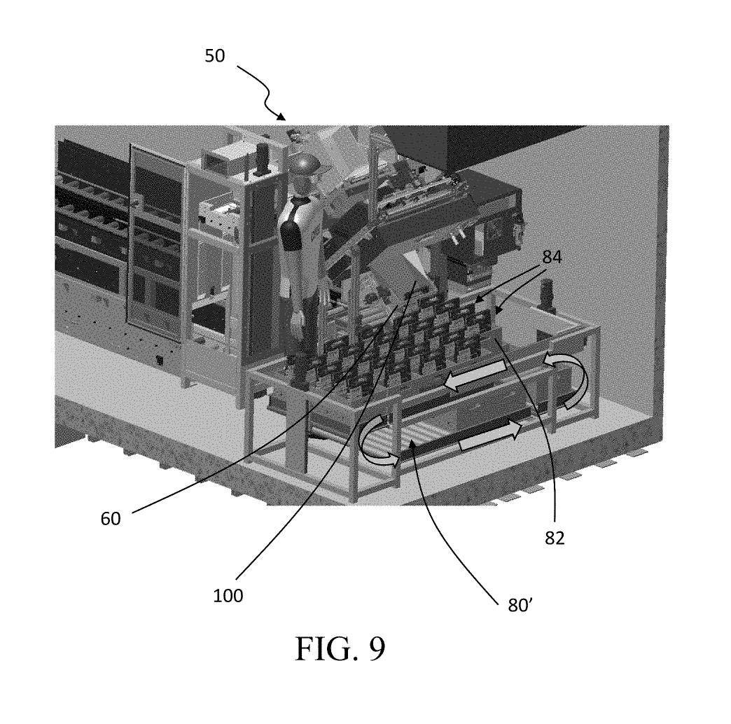

During use, as shown in FIGS. 8A, 8B, and 9, container 100 may be released into one of a plurality of recesses 84 that are defined by container totes 82. Container totes 82 may be supported on the second conveyor 80 (FIGS. 8A and 8B), 80′ (FIG. 9) that, in conjunction with the container totes 82 are configured to support the containers 100 after they have been filled with items. Container totes 82 and second conveyor 80, 80′ are configured to optimize the number of full containers 100 that may be staged prior to removal from the truck 90. This optimization allows the system 20 to run for long periods while minimizing the frequency with which an operator of the system 20 needs to stop to collect the full containers 100. As shown in FIG. 9, second conveyor 80′ may include an elevator portion that may be used to store the container totes 82 in two or more levels. Container totes 82 may be recirculated as the system 20 continues to operate in order to provide for continuous operation of the system 20.

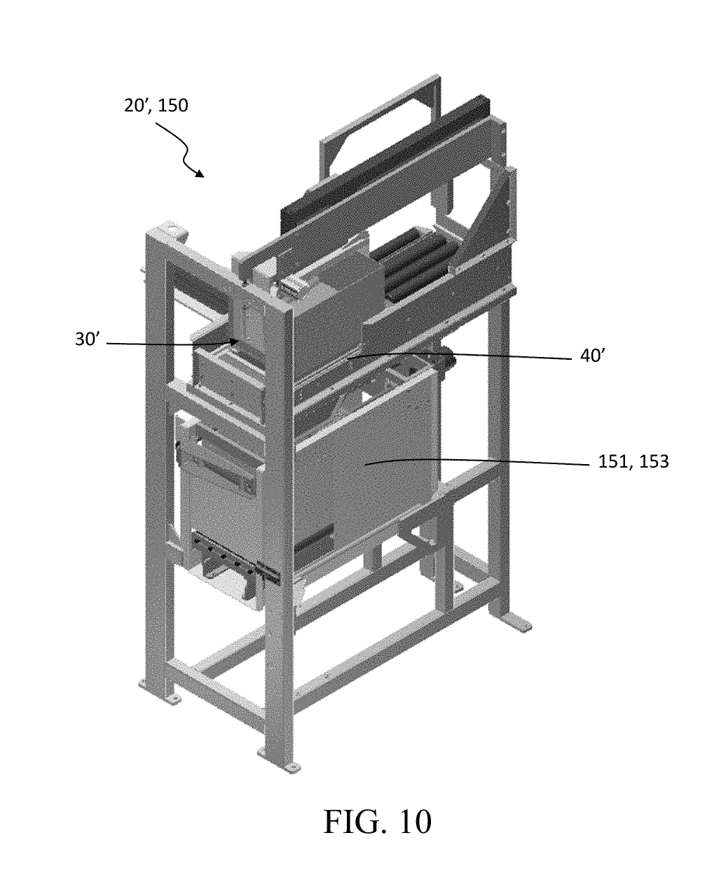

Referring now to FIGS. 10-14F to illustrate a second embodiment, the second embodiment transportable system 120 for packaging items 99 in a container 100′ includes a packaging system 150 that has a container former 151, item totes 130, and a conveyor 140.

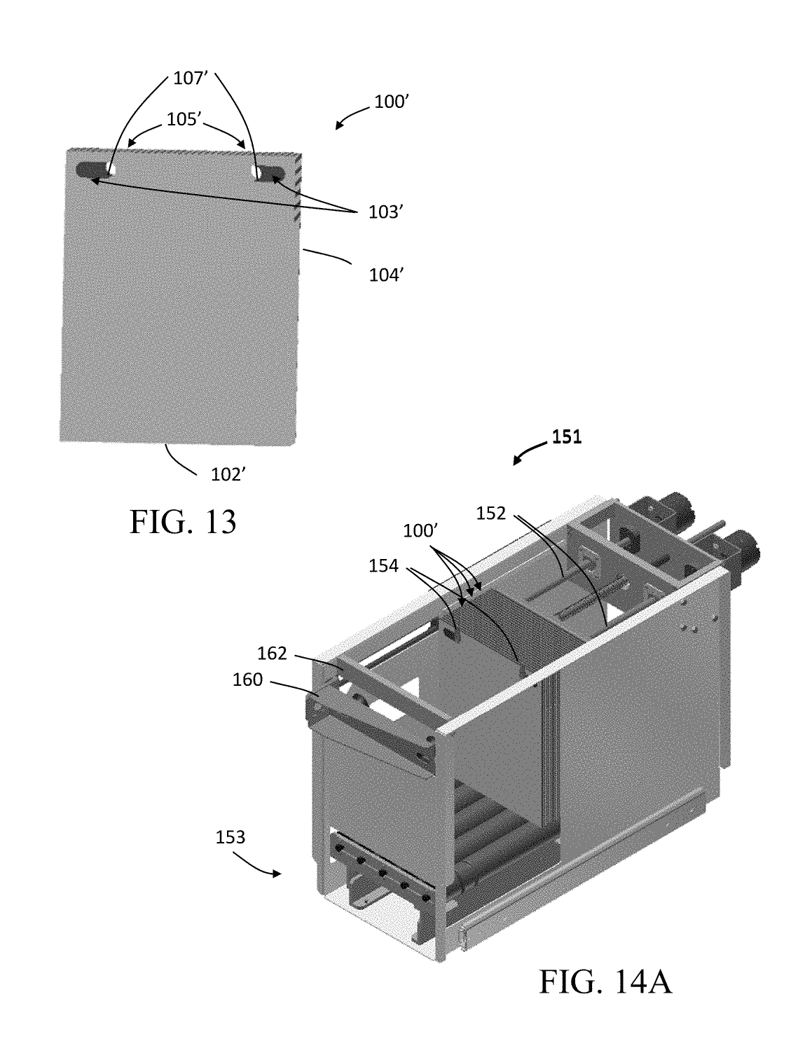

With reference to FIG. 13, the container 100′ has a base 102′ and at least one sidewall 104′ that extends up from the base 102′. For example, container 100′ may have a rectangular cuboid shape. Container 100′ includes two sets of slots 103′, 105′ which are offset relative to each other and which together define a pair of recesses 107′. The first set of slots 103′ is defined by the front sidewall 104′ of the container 100′. The second set of slots 105′ is defined by the back sidewall 104′. Recesses 107′ are defined by both the front and back sidewalls 104′.

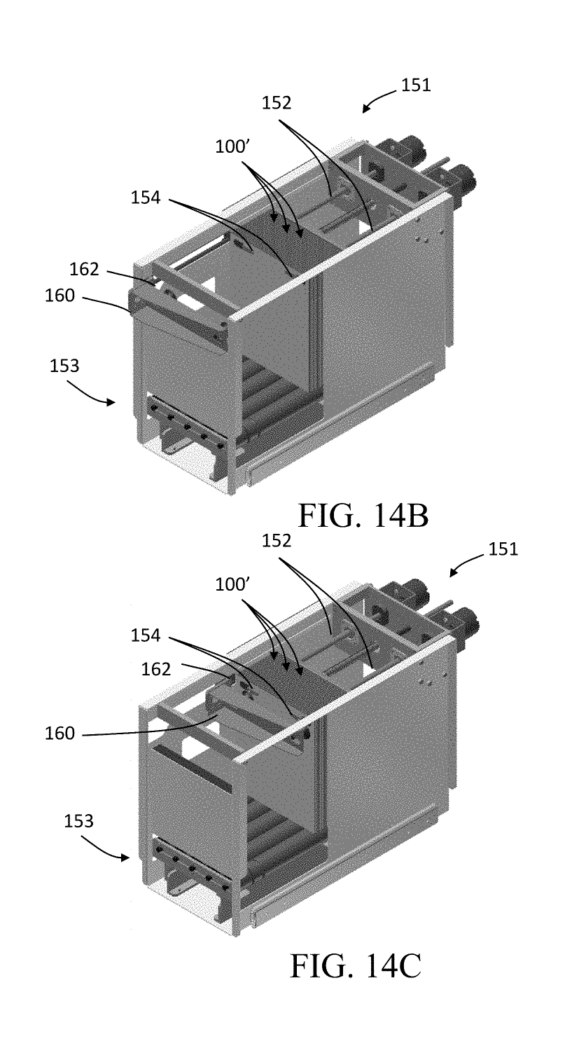

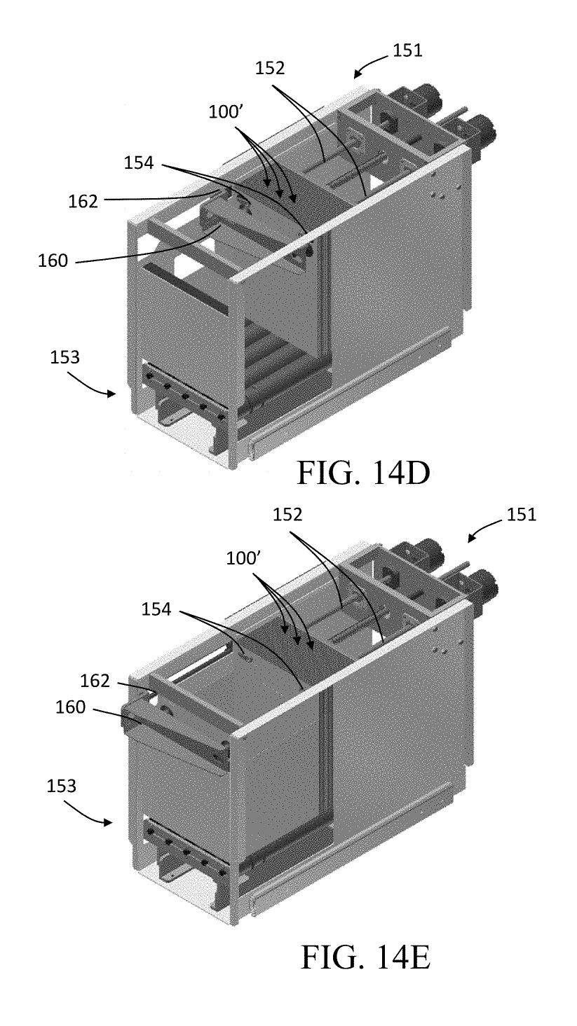

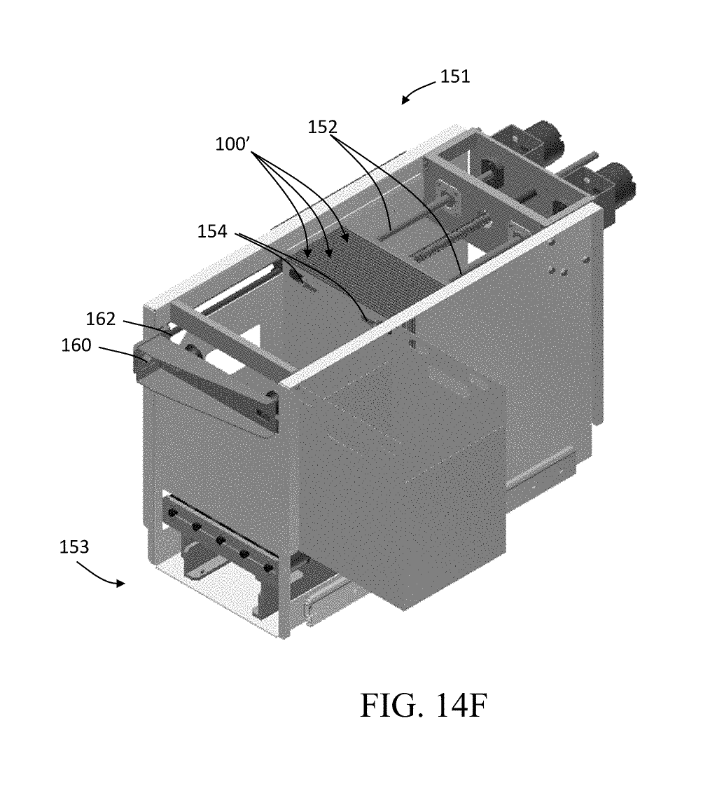

Referring now to FIGS. 14A-14F, offset slots 103′, 105′ are used in combination with container former 151 to form the containers 100′. Container former 151 includes a body 153 to which a pair of dowels 152 are mounted. Each dowel 152 has a tab 154 that extends radially from the dowel 152 and is rotatable relative to the dowel 152 or with dowel 152 relative to the body 153. Tabs 154 are similarly sized and shaped and slightly smaller than slots 103′, 105′. The container former 151 includes a vacuum arm 160 through which a vacuum force may be applied to the container 100′.

With reference to FIG. 14A, prior to formation, containers 100′ are hung on the pair of dowels 152 using the pair of recesses 107′. As shown in 14A, tabs 154 are initially oriented upward so as to facilitate stacking the containers 100′ on the dowels 152. Referring to FIGS. 14B and 14C, tabs 154 may then be turned inward while the vacuum force is being applied to the front sidewall 104′ of the container 100′ by vacuum arm 160. While the tabs 154 are rotated inward, both the front and back sidewalls 104′ are locked in place together. With the vacuum arm 160 applying the vacuum force to the front sidewall 104′ of the container 100′, as shown in FIG. 14D, the tabs may be rotated outwardly so as to be aligned with slots 103′, releasing the front sidewall 104′, while keeping back sidewall 104′ locked in place. With the back sidewall 104′ locked by the tabs 154, vacuum arm 160 is actuated by a linear actuator 162 to move the vacuum force so as to separate the front sidewall 104′ from the back sidewall 104′ (shown in FIG. 14E). As shown in FIG. 14F, the tabs 154 are then again rotated inwardly so as to release slots 105′ and, with the slots 105′, the entire container 100′. The tabs 154 are then in position for the next container 100′ to be formed.

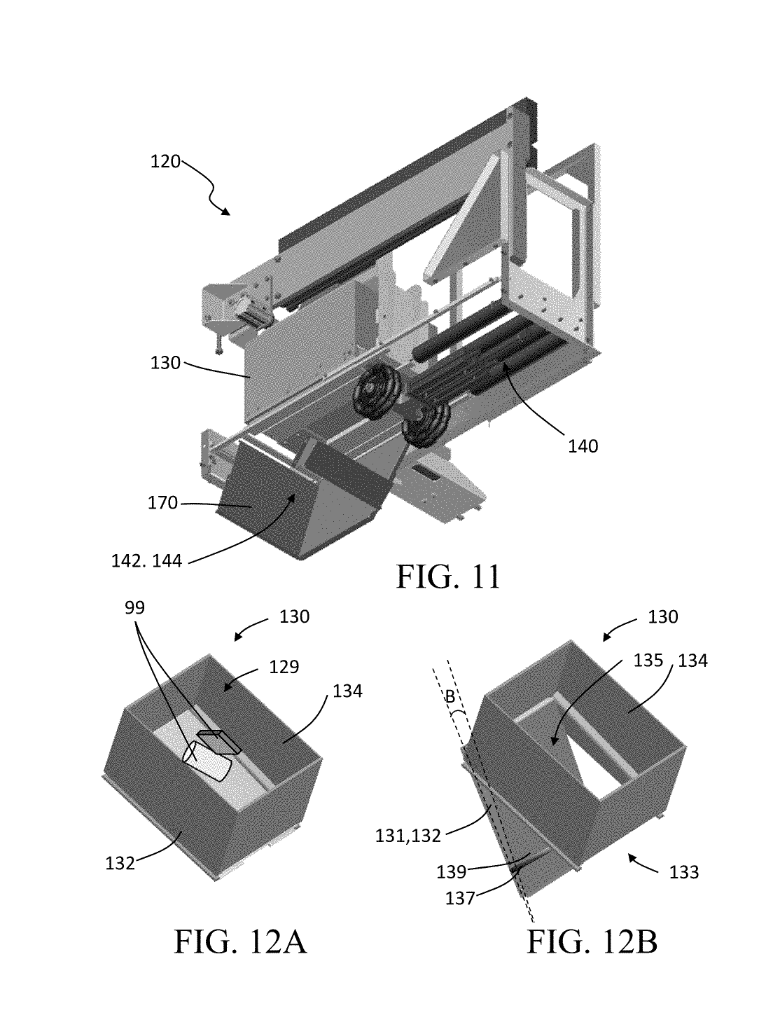

Prior to removing the container 100′ from the container former 151, items 99 may first be placed into the container. With reference again to FIGS. 10 and 11, after item tote 130 is carried by the conveyor 140 from area 91 to the packaging system 150, item tote 130 is disposed over the expanded container 100′ in the container former 151. As shown in FIGS. 12A and 12B, each item tote 130 has a base 132 and at least one sidewall 134 extending up from the base 132. For example, item tote 130 has a generally rectangular cuboid shape and defines an aperture 129 through which items 99 pass from the dispensing carts 21 into the item tote 130. The at least one sidewall 134 includes four sidewalls 134. The base 132 has an inner surface 135 and an outer surface 136 that are angled relative to each other at an angle B. Angle B may be between 0 and 15 degrees, for example, between 0 and 10 degrees, such as between 5 and 10 degrees. Inner surface 135 may further define a lip 137 disposed between the inner surface 135 and the sidewall 134.

During use, items 99 dropped into item tote 130 may move (e.g., roll) along the inner surface 135 towards a low point 139 on the inner surface, and over lip 137 due to the angle B and gravity. Lip 137 inhibits items 99 from moving back onto inner surface 135. As described above, dispensing carts 21 may be configured along conveyor 140 such that heavier and more structurally stable items (e.g., a can of soda) are placed (e.g., dropped) into the item tote 130 prior to lighter and less structurally stable items (e.g., a bag of chips). When a heavier item 99 is placed into the item tote 130, it will move down the inner surface 135 to the low point 139 and over lip 137 where it is held between lip 137 and sidewall 134. Lighter and less structurally sound items 99 may then be placed into item tote 130, for example, in order of heaviest to lightest items, or in order of most structurally sound to least structurally sound, or a combination thereof.

The base 132 of item tote 130 includes a door 131 that is configured to actuate from a first position (shown in FIG. 12A) to a second position (shown in FIG. 12B) to form an aperture 133. Door 131 may, for example, be secured to the other sidewalls 34 using a latch. Door 131 is configured to be rotatable relative to the at least one sidewalls 134. In other embodiments, item tote 130 may have, for example, a cylindrical shape.

As shown in FIG. 11, conveyor 140 defines a recess 142 that, in combination with door 131 is configured to form a pathway 144 from the item tote 130 to the container former 150 such that items may be disposed in the container 100′ after the container 100′ is formed. For example, when the item tote 130 is disposed over recess 142, the latch may may be released to form pathway 144. An item chute 170 may be used to guide items 99 along pathway 144.

Once items 99 are disposed in container 100′, container 100′ may be removed from the container former 151 and into one of the plurality of recesses 84 that are defined by the container totes 82. Container totes 82 may be disposed below container former 151 and supported on the second conveyor 80.

The item totes 30, 130, containers 100, 100′, conveyors 40, 140, and packaging systems 50, 150 may be interchangeable such that portions of the system described in relation to FIGS. 4-9 may be combined with portions of the system described in relation to FIGS. 10-14F. For example, the packaging system 50 of transportable system 20 may be replaced with packaging system 150 of transportable system 120. Specifically, container former 151 may be disposed under conveyor 40, including actuatable portion 46. Container former 151 may be angled so as to form angle A2 with the main portion 44 of the conveyor 40 such that dowels 152 extend parallel to plane P3. In a further aspect of the disclosure, container former 151 may be rotatable relative to plane P3 such that container former 151 has a first position during filing and a second position for removing the container 100′ from the container former 151.

In another example, item tote 130 and conveyor 140 may be used in conjunction with packaging system 50. Packaging system 50 may be disposed such that plane P3 is perpendicular to the conveyor 140 such that when door 131 is released so as to form pathway 144, items 99 drop into container 100.

The present invention is illustrated employing totes. The present invention is not limited to totes. Rather, the invention encompasses the use of bags, boxes, and like containers. Further, any of the components and methods of described in U.S. Pat. No. 9,114,748, including without limitation the conveyor technology and dispensing cart technology, may be employed with the components and methods described herein.

Additional changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the claims.

What is claimed:

1. A transportable system for packaging items in a container, the system being mounted to and enclosed by a truck, the system comprising:
an item tote having a base and at least one sidewall extending from the base;
a conveyor configured to transport the item tote within the truck, the conveyor having an actuatable portion that is configured to tilt the item tote;
dispensing carts located above the conveyor and removable from the truck for loading items into the dispensing carts while the dispensing carts are outside of the truck; and
a container chute;
whereby, in operation, items are dispensed from the dispensing carts into the item tote and transported by the conveyor to a container disposed in the container chute.

2. The transportable system of claim 1, wherein the container has a base and at least one sidewall extending from the base, the base of the item tote has a bottom surface that defines a first plane, the conveyor has a top surface that contacts the bottom surface of the item tote, the top surface has a main portion that defines a second plane, and the conveyor is configured to tilt the item tote from a first position in which the first plane is coplanar with the second plane and a second position in which the first plane is at a first angle relative to the second plane, and wherein the container chute has a surface that extends between a top portion proximate the conveyor and a bottom portion, the surface configured to contact the at least one sidewall of the container, the surface of the container chute defining a third plane, the third plane being disposed at a second angle relative to the second plane, the first angle being within 10 degrees of the second angle.

3. The transportable system of claim 2, further comprising a shelf disposed proximate the bottom portion of the container chute, the shelf being actuatable relative to the container chute between a first position in which the shelf supports the base of the container and a second position in which the container is released from the shelf.

4. The transportable system of claim 2, wherein the item tote further comprises a door configured to actuate to form an aperture as the item tote moves from the first position to the second position.

5. The transportable system of claim 4, wherein the system further comprises a cam mounted to a linear actuator configured to actuate the door.

6. The transportable system of claim 2, wherein the item tote further comprises an inner surface that defines a fourth plane, the fourth plane being disposed relative to the first plane at a third angle, the third angle being between 0 and 10 degrees.

7. The transportable system of claim 6, wherein the item tote further comprises a lip disposed between the inner surface and the at least one sidewall.

8. The transportable system of claim 1 further comprising an item chute disposed between the conveyor and the container chute.

9. The transportable system of claim 1, wherein the conveyor is a first conveyor and the system further comprises a second conveyor and a plurality of container totes disposed on the second conveyor, each the container totes defining a plurality of recesses, each of the recesses configured to receive the container.

10. A method of packaging items in a container using a transportable system that is mounted to and enclosed by a truck, the system comprising an item tote having a base and at least one sidewall extending from the base, a conveyor, dispensing carts located above the conveyor and removable from the truck for loading items into the dispensing carts while the dispensing carts are outside of the truck, and a container chute, the method comprising:
disposing items in the item tote;
after the disposing step, transporting the item tote from an area within the truck where the dispensing carts are disposed to the container chute; and
after the transporting step, moving the items from the item tote into the container.

11. The method of claim 10, wherein the container has a base and at least one sidewall extending from the base, the base of the item tote has a bottom surface that defines a first plane, conveyor has a top surface having a main portion that defines a second plane, and an actuatable portion, the container chute has a surface that extends between a top portion proximate the conveyor and a bottom portion, the surface of the container chute defining a third plane, and wherein:
the moving step further comprises tilting the item tote from a first position in which the first plane is coplanar with the second plane to a second position in which the first plane is at a first angle relative to the second plane, the tilting resulting in the items moving from the tote to the container, the container being disposed on the container chute and the container chute being disposed at a second angle relative to the second plane, the first angle being within 10 degrees of the second angle; and

12. The method of claim 11 wherein the system further comprises a shelf disposed proximate the bottom portion of the container chute and the method further comprises a step of actuating the shelf relative to the container chute between a first position in which the shelf supports the base of the container to a second position in which the container is released from the shelf.

13. The method of claim 10, wherein the disposing step comprises multiple steps of dropping the items into the tote, the items including a first item having a first weight and a second item having a second weight, respectively, the first weight being greater than the second weight, and a step of dropping the first item into the tote occurs prior to the step of dropping the second item into the tote.

14. The method of claim 13, wherein the item tote further comprises an inner surface that defines a first plane, the first plane being disposed relative to a second plane defined by the bottom surface of the item tote at an angle, the angle being between 0 and 10 degrees, and the step of dropping the first item results in the first item rolling toward a low point on the inner surface.

15. The method of claim 14, wherein the rolling includes rolling the first item over a lip disposed between the inner surface and the at least one sidewall and the step of dropping the second item includes dropping the second item on the inner surface.

16. The method of claim 15, further comprising a step of actuating a door of the item tote so as to form an aperture, the actuating step beginning before or during the moving step.

17. A transportable system for packaging items in a container, the container having a base and at least one sidewall extending from the base, the system being mounted to and enclosed by a truck, the system comprising:
a container former, the container former comprising:
a pair of dowels, each dowel having a tab extending radially relative to the dowel;
a vacuum arm, the vacuum arm configured to apply a vacuum force to the container during forming; and
a linear actuator mounted to the vacuum arm, the linear actuator configured to move the vacuum arm relative to a portion of the container during forming;
an item tote having a base and at least one sidewall extending from the base, the base including a door that is actuatable relative to the at least one sidewall; and
a conveyor configured to transport the item tote within the truck, the conveyor defining a recess that, in combination with the door, is configured to form a pathway from the item tote to the container former such that the items may be disposed in the container after the container is formed.

18. The transportable system of claim 17, wherein the base of the item tote comprises an inner surface and an outer surface that are angled relative to each other at an angle being between 0 and 10 degrees.

19. The transportable system of claim 18, wherein the inner surface of the item tote defines a lip.
